(19) United States
(12) Patent Application Publication
(10) Pub. No.: US 2024/0296112 A1
(43) Pub. Date: Sep. 5, 2024

(54) COMPUTER-IMPLEMENTED METHOD FOR TESTING THE EXECUTION OF AT LEAST ONE CONTROL UNIT FUNCTION ON A SIMULATOR, AND CORRESPONDING SIMULATOR

(71) Applicant: dSPACE GmbH, Paderborn (DE)

(72) Inventors: Stephan SCHEDLER, Paderborn (DE); Stjepan POLJAK, Zagreb (HR)

(73) Assignee: dSPACE GmbH, Paderborn (DE)

(21) Appl. No.: 18/593,244

(22) Filed: Mar. 1, 2024

(30) Foreign Application Priority Data
Mar. 2, 2023 (DE) 10 2023 105 179.2
Aug. 7, 2023 (EP) 23189912.1

(51) Int. Cl. G06F 11/36

(52) U.S. Cl. CPC G06F 11/3692; G06F 11/3664

(57) ABSTRACT

A computer-implemented method to test an execution of at least one control unit function of a control unit via at least one computing unit of a simulation environment on a simulator. The control unit function is executed with a zero-time assumption of a discretely advancing simulation time between successive simulation steps in an event-oriented discrete simulation on the simulator. A cause of deadlock situations in the simulation are identified in that an observation service operated on the simulator compares the advance of the discrete simulation time with the advance of a simulator real time and, if the advance of the simulator real time beyond the advance of the discrete simulation time exceeds a predetermined limit value, at least indirectly creates stack traces of the at least one computing unit.

This nonprovisional application claims priority under 35 U.S.C. § 119 (a) to German Patent Application No. 10 2023 105 179.2, which was filed in Germany on Mar. 2, 2023, and to European Patent Application No. 23189912.1, which was filed on Aug. 7, 2023, and which are both herein incorporated by reference.

### BACKGROUND OF THE INVENTION

### Field of the Invention

The invention relates to a computer-implemented method for testing the execution of at least one control unit function of a control unit by means of at least one computing unit of a simulation environment on a simulator, wherein the control unit function is executed with a zero-time assumption of a discretely advancing simulation time between successive simulation steps in an event-oriented discrete simulation on the simulator. In addition, the invention also relates to a corresponding simulator having at least one computing unit, wherein a simulation environment is operated with a computing unit in the operating state of the simulator on the computing unit, wherein at least one control unit function of a control unit is executed with the computing unit of the simulation environment with a zero-time assumption of a discretely advancing simulation time between successive simulation steps in an event-oriented discrete simulation on the simulator.

### Description of the Background Art

Computer-implemented methods of the abovementioned type and corresponding simulators serve to test control unit functions, which is to say functions that are to be implemented in software on electronic control units. This relates specifically to early development stages in which the electronic control unit (ECU) that the control unit function is intended for does not yet even exist in hardware. Instead, a simulation environment that (virtually) models a possible control unit, including the computing unit of the control unit, is operated on a simulator, oftentimes a powerful PC, so that it is possible to execute, and thus test, the control unit function within the framework of the simulation environment. A corresponding simulation environment as well as corresponding simulators are developed by the applicant under the name “VEOS.” Frequently the control unit for which the control unit function is intended is modeled in software, which is to say emulated, with the simulation environment. The emulation also includes the computing unit of the control unit, so the simulation environment also has a corresponding computing unit, and thus even hardware-oriented functionalities are accessible and can be tested.

The simulations are event-oriented discrete simulations (discrete-event simulation) as opposed to time-driven simulations. With both types of simulation, the simulation is executed in discrete time steps, as is customary for sampled-data systems and for the numerical, discrete-time calculation of models: In other words, the simulation time advances in discrete time steps during the course of the simulation. With time-driven simulations, however, there is a physical real time that is known on the simulator and which, for example, is provided as a simulator real time of an internal, physical clock, wherein the advancing of the simulator real time automatically leads to the advancing of the simulation time, and thus to the automatic transition from one simulation step to the next simulation step. In the case of the event-driven simulations considered here, there is no dependence of the simulation time on a physical simulator real time. The different items to be calculated, such as, e.g., the control unit function to be executed, are executed in each simulation step, wherein the duration of the execution in the respective simulation step does not matter. A branch is made from one simulation step to the next when all calculations of the one simulation step are finished, which is to say the event of the completion of the calculation of all control unit functions has occurred. Since the actual execution time is not of interest, and thus effectively only the discrete time points of the respective simulation steps exist, the so-called zero-time assumption is spoken of in the case of the event-oriented discrete simulation considered here.

During testing of control unit functions with the simulation environment of a simulator it happens that deadlocks occur in the simulation, which is to say the simulation does not continue running, and thus is effectively stuck in one simulation step, or in other words the discretely advancing simulation time does not advance.

### SUMMARY OF THE INVENTION

It is therefore an object of the present invention to improve a method and a relevant simulator in such a manner such that the causes of such deadlocks can be discovered.

In an example, the object is attained in that an observation service operated on the simulator compares the advance of the discrete simulation time with the advance of a simulator real time. The simulator real time can be understood as it was described above. It is time information available on the simulator for a physical time, which therefore must perforce advance and is not dependent on the simulation. It does not matter where this time information comes from, whether it is generated on a physical computing unit of the simulator, whether it comes from a higher-level clock, or whether it is regularly transmitted from an external clock to the simulator; what is important is that it is time information that is independent of the simulation.

If the advance of the simulator real time beyond the advance of the discrete simulation time exceeds a predetermined limit value, a plurality of stack traces of the at least one computing unit are created. The computing unit is the computing unit-modeled within the framework of the simulation environment—of the control unit for which the control unit function is intended. A stack trace is understood generally here as an image, which is to say a snapshot, of the internal operating system information regarding the control unit functions executed or called on the computing unit. Here, too, it is the computing unit of the control unit modeled within the framework of the simulation environment that is meant. By means of the stack trace, it is therefore evident which control unit functions have been called at the current point in time of the creation of the stack trace in question. The circumstance that the creation of the stack traces is tied to the precondition of the result of a comparison between the simulation time and the simulator real time has substantial efficiency advantages in contrast to a possible method in which stack traces are continually created regardless of whether there is an indication of a deadlock state.

In an analysis step, at least the most frequent control unit function that the at least one computing unit, which is to say the computing unit of the simulation environment, has executed most frequently at the time of the creation of the respective stack trace is identified by analysis of the stack traces. The identified most frequent control unit function is displayed and/or further processed or at least stored as information.

It has been discovered that deadlock states in event-oriented discrete simulations frequently lead to an “active” deadlock in which a control unit function is continuously active and is not terminated. This understanding differs from the customary understanding of a deadlock situation in which different control unit functions often wait for one another, but the control unit functions themselves are not active. In the case of such a deadlock, the computing unit is not working at full capacity. The circumstance of the active deadlock in an event-oriented discrete simulation has the result that it is possible to discover with the aid of the capture of stack traces which control unit function is actively deadlocked.

The observation service can be executed as a component of the simulation environment, especially preferably within the framework of an emulation of the control unit that is executed by the simulation environment.

Provision may be made that the observation service either triggers at least one non-maskable interrupt of the computing unit of the simulation environment, which triggers the creation of the plurality of stack traces of the at least one computing unit of the simulation environment, or that the observation service triggers a non-maskable interrupt of the computing unit of the simulation environment multiple times, each of which triggers the creation of a stack trace of the at least one computing unit of the simulation environment, and in this way a plurality of stack traces is also created. In an alternative improvement of the method, provision is made that the observation service signals that the advance of the simulator real time beyond the advance of the discrete simulation time exceeds a predetermined limit value, and, in response to the signaling, a user triggers at least one non-maskable interrupt that in turn then triggers the creation of the plurality of stack traces of the at least one computing unit of the simulation environment.

In an example, the observation service unconditionally records the plurality of stack traces one after another or triggers the creation of such a plurality of stack traces, in particular at fixed intervals of simulator real time; preferably more than ten stack traces, especially preferably one hundred or more, are recorded, which improves the validity of the statistical evaluation.

The plurality of stack traces can be created for all computing units of the simulation environment, and that, preferably in the analysis step, the stack traces of all computing units are analyzed together and the most frequently executed control unit function is identified and preferably is displayed. As a result of this measure, all executed control unit functions are reliably captured, in particular when the distribution of the control unit functions among the different computing units of the control unit and thus among the computing units of the simulation environment, which of course model the different computing units of the control unit, is not predictable. This can be the case, for example, because the simulation environment distributes control unit functions or executable code derived therefrom among the computing units according to its own rules and as a function of variable states of the simulation environment and/or of the computing units of the simulation environment.

In the analysis step, the n most frequent control unit functions that the at least one computing unit has executed most frequently at the time of the creation of the respective stack trace can be identified, in particular the identified n most frequent control unit functions can be displayed. As a result of this measure, multiple control unit functions involved in a deadlock can be discovered as well. Furthermore, notable frequencies in the execution of certain control unit functions can also be detected.

For the case in which multiple control unit functions are executed on multiple computing units of the simulation environment, provision is made that at least the most frequent control unit function that the respective computing unit has executed most frequently at the time of the creation of the respective stack trace is identified for the multiple computing units in the analysis step, and that the identified most frequent control unit function for the respective computing unit is displayed, in particular wherein at least the most frequent control unit function is identified for all computing units. This permits the discovery of multiple deadlocking control unit functions on different computing units.

The object derived above is likewise attained with the initially described simulator, which carries out the above-described method in operation.

In particular, there is proposed a plurality of possibilities for implementing and further developing the method according to the invention for testing the execution of at least one control unit function of a control unit by means of at least one computing unit of a simulation environment on a simulator.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a computer-implemented method for testing the execution of at least one control unit function of a control unit by means of at least one computing unit of a simulation environment on a simulator, and the corresponding simulator, wherein the computing unit of the simulation environment is simulated within the framework of an emulation,

FIG. 2 schematically shows the method for testing the execution of a control unit function and the simulator used for the purpose, wherein the computing unit of the simulation environment is realized in hardware by an FPGA,

FIG. 3 schematically shows the method for testing the execution of a control unit function as well as the simulator used for the purpose, wherein the computing unit of the simulator is used as a computing unit of the simulation environment, and

FIG. 4 schematically shows the method for testing the execution of a control unit function with multiple computing units of the simulation environment.

### DETAILED DESCRIPTION

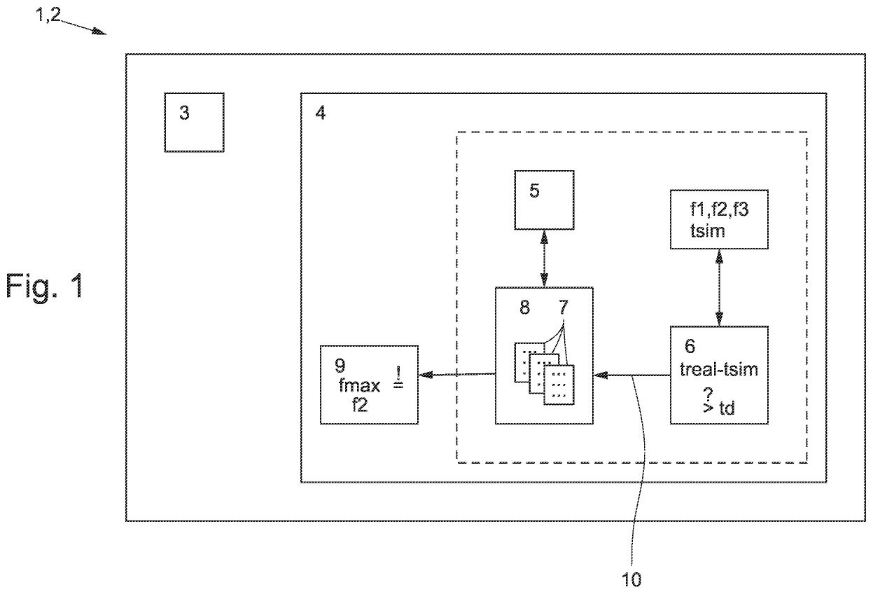

FIGS. 1 to 4 each schematically show a computer-implemented method 1 for testing the execution of at least one control unit function f1, f2, f3 of a control unit. The control unit is not represented, since it is not required for carrying out the method 1. The typical use case in which the method 1 represented here is employed relates particularly to the situation in which the software for a control unit has already been developed even though the control unit does not yet exist in hardware, but nevertheless the software functionality is to be tested already. For this reason, the control unit is modeled with a simulator 2, and reference is therefore also made to testing of control unit software on a virtual control unit.

The simulators 2 shown here have a computing unit 3. In the present case, the simulator 2 is a PC operated with the Linux operating system, although other configurations are of course entirely possible. A simulation environment 4 is operated on the simulator 2, and thus on the computing unit 3 of the simulator 2. The simulation environment 4 serves to simulate the control unit for which the control unit functions f1, f2, f3 have been created. In this regard, the simulation environment 4 for its part has a computing unit 5, wherein this computing unit 5 models the computing unit of the control unit for which the control unit functions f1, f2, f3 are intended.

The representations in the figures are also schematic to the extent that the computing unit 3 of the simulator 2 and the computing unit 5 of the simulation environment 4 are shown for the sake of completeness and the functionalities operated on these computing units 3, 5, which is to say the simulation environment 4 in the case of the computing unit 3 of the simulator 2 as well as the control unit functions f1, f2, f3 in the case of the computing unit 5 of the simulation environment 4, are shown next to one another and not nested within one another. The assignments of functionalities to the places where they are executed take place as needed through the description of the figures.

The method 1 and simulators 2 shown in the figures have in common at least that the control unit functions f1, f2, f3 are executed with a zero-time assumption of a discretely advancing simulation time tsim between successive simulation steps in an event-oriented discrete simulation on the simulator 2. As has already been explained in the general description section, such simulations are distinguished in that all necessary calculations are carried out in each discrete simulation step regardless of the actual time duration for these calculations. A branch to the next simulation step is made when all calculations in the previous simulation step have been completed. Since the time duration between the individual, discrete simulation steps is irrelevant in the event-driven simulation, the aforementioned zero-time assumption is spoken of.

In the simulations, the situation can arise that the calculation of a control unit function f1, f2, f3 is not completed (“active deadlock”)—for whatever reason-so that the event-oriented discrete simulation cannot advance, and the discrete simulation time tsim remains at one value.

With the method 1 shown in the figures, it is possible to discover the causes of such deadlocks and to respond to them if necessary. This is realized in all the examples shown by the means that an observation service 6 operated on the simulator 2 compares the advance of the discrete simulation time tsim with the advance of a simulator real time treal. The simulator real time treal is a time available on the simulator 2 which advances unchecked, in particular which is completely independent of the progress of the simulation on the simulator 2. If the advance of the simulator real time treal beyond the advance of the discrete simulation time tsim exceeds a predetermined limit value td, a plurality of stack traces 7 of the at least one computing unit 5 are at least indirectly created. The stack traces 7 are snapshots of the internal operating system information regarding the control unit functions f1, f2, f3 executed on the computing unit 5 of the simulation environment 4. In an analysis step 8, at least the most frequent control unit function fmax that the computing unit 5 of the simulation environment 4 has executed most frequently at the time of the creation of the respective stack traces 7 is identified by analysis of the stack traces 7. The identified most frequent control unit function fmax is displayed and/or also further processed. A possible further processing includes that the execution of the simulation within the framework of the simulation environment 4 is stopped.

In the example from FIG. 1, the control unit for which the control unit functions f1, f2, f3 are intended is emulated with the simulation environment 4, indicated by the dashed line that surrounds the computing unit 5, the control unit functions f1, f2, f3, the observation service 6, and the creation of the stack traces 7. These functionalities are performed within the framework of the control unit emulation. In actual fact, the observation service 6 could also be performed outside the control unit emulation, just like the initiation of the creation 8 of the multiple stack traces 7. The observation service 6 could also be performed outside the simulation environment 4—it is only necessary to ensure that the simulation time tsim is made available to the observation service 6 through a suitable interface. Additional variations are also possible here, although the particulars are not significant.

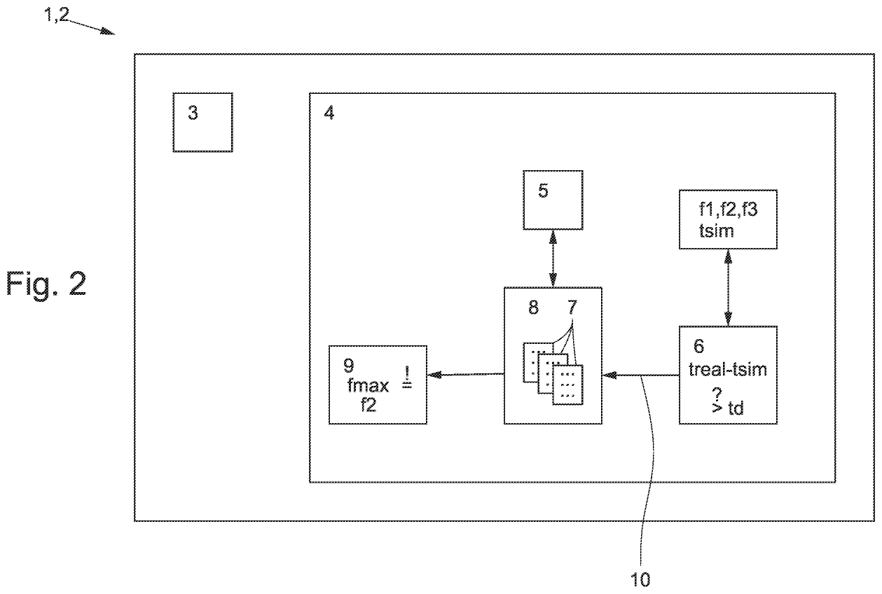

In the example from FIG. 2, the control unit functions f1, f2, f3 are not actually executed on an emulated control unit with a simulated computing unit, but instead on a computing unit 5 of the simulation environment 4, which is implemented as an FPGA (Field Programmable Gate Array). All that is critical is that the control unit function f1, f2, f3 is executed with a zero-time assumption of the discretely advancing simulation time tsim in an event-oriented discrete simulation.

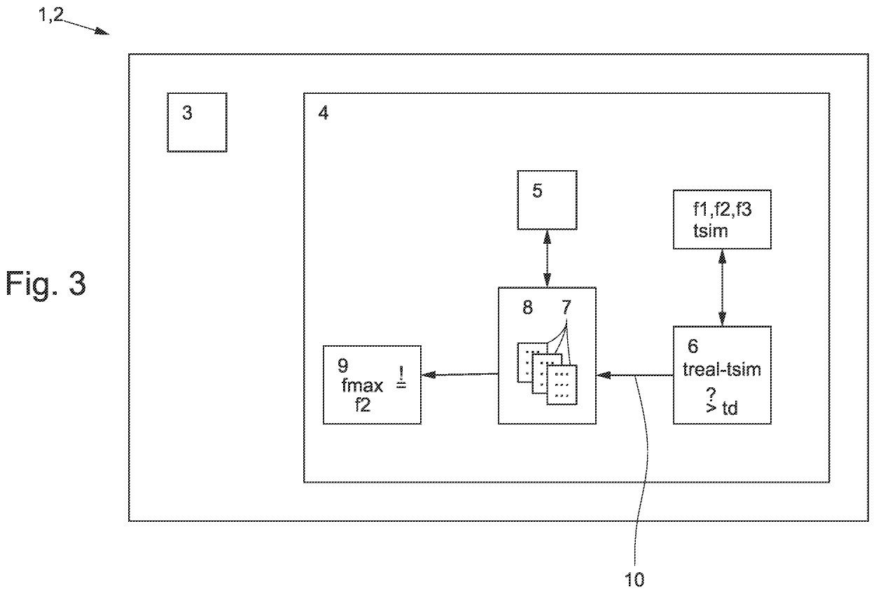

The simulator in FIG. 3 is characterized in that the control unit functions f1, f2, f3 are executed on the computing unit 5 of the simulation environment, wherein the computing unit 3 of the simulator 2 is used directly as computing unit 5 of the simulation environment 4. This is thus a hypervisor solution, with which the hardware of the simulator 2, in particular the computing unit 3 of the simulator 2, can be accessed so that the control unit function f1, f2, f3 can be executed on the computing unit 3 of the simulator 2. The computing unit 3 of the simulator 2 and the computing unit 5 of the simulation environment 4 are identical here in practice.

In the case of the method 1 shown, the observation service 6 triggers a non-maskable interrupt 10 of the computing unit 5 of the simulation environment 4 if the advance of the simulator real time treal beyond the advance of the discrete simulation time tsim exceeds a predetermined limit value td. According to the customary understanding, a non-maskable interrupt cannot be disabled, or in other words it is impossible to prevent the interrupt service routine associated with it from also being executed upon triggering of the interrupt. The creation 8 of the plurality of stack traces 7 of the computing unit 5 of the simulation environment 4 is tied to the non-maskable interrupt 10, so that the plurality of stack traces 7 is also captured as a result of the triggering of the non-maskable interrupt 10. The arrow shown in the figures to symbolize the action of the triggering of the non-maskable interrupt 10 is an abbreviated representation of the complete sequence of actions: Represented in detail, the observation service 6 acts on the interrupt functionality of the computing unit 5, which in turn triggers the creation 8 of the plurality of stack traces 7. In the example in FIG. 1, the interrupt 10 is a non-maskable interrupt 10 of the emulated computing unit 5 of the control unit, in the case of FIG. 3 the interrupt 10 is a non-maskable interrupt 10 of the computing unit 3 of the simulator 2.

In the examples shown, the plurality of stack traces 7 are unconditionally recorded 8 one after the other, in the present case at fixed intervals of simulator real time treal. As a suitable basis for the analysis of the stack traces 7 with regard to the frequency of execution of the control unit functions f1, f2, f3, it has proven to be advantageous when at least some tens of stack traces are created 8, in the examples shown, one hundred stack traces are created 8.

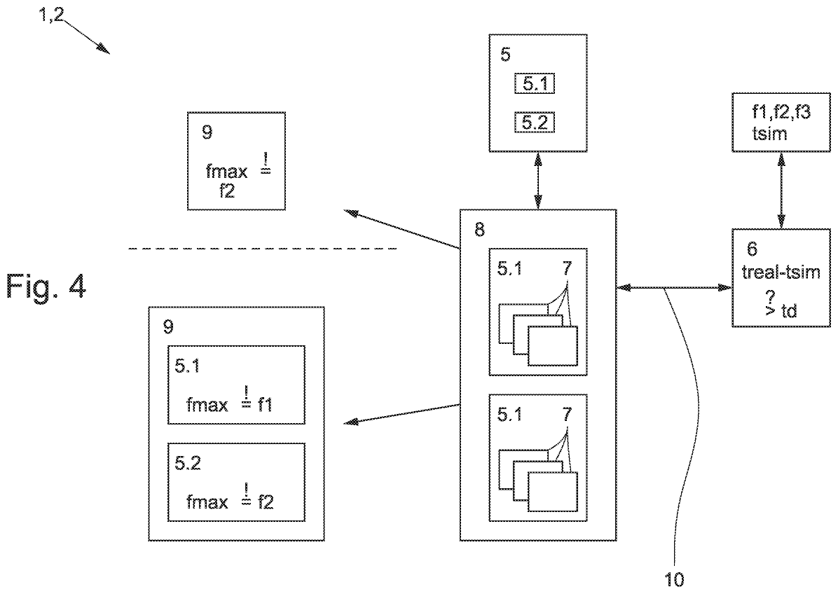

FIG. 4 shows examples of the method 1 when the simulation environment 4 has multiple computing units 5.1 and 5.2. The plurality of stack traces 7 are created for all computing units 5.1, 5.2 of the simulation environment 2. In the example at the top, the stack traces 7 of all computing units 5.1, 5.2 are analyzed together in the analysis step 9, and the most frequently executed control unit function fmax,total is identified and displayed (fmax,total=! f2).

In the example shown at the bottom left in FIG. 4, at least the most frequent control unit function fmax that the respective computing unit 5.1, 5.2 has executed most frequently at the time of the creation of the respective stack trace 7 is identified for multiple computing units 5.1, 5.2 in the analysis step. Furthermore, the identified most frequent control unit function fmax for the respective computing unit 5.1, 5.2 is displayed.

What is claimed is:

1. A computer-implemented method to test an execution of at least one control unit function of a control unit via at least one computing unit (5) of a simulation environment on a simulator, the control unit function being executed with a zero-time assumption of a discretely advancing simulation time between successive simulation steps in an event-oriented discrete simulation on the simulator, the method comprising:
comparing, via an observation service that is operated on the simulator, an advance of a discrete simulation time with an advance of a simulator real time;
creating at least indirectly, if the advance of the simulator real time beyond the advance of the discrete simulation time exceeds a predetermined limit value, a plurality of stack traces of the at least one computing unit;
identifying, in an analysis step, at least the most frequent control unit function that the at least one computing unit has executed most frequently at the time of creation of the respective stack trace by analysis of the stack traces; and
displaying and/or further processing the identified most frequent control unit function.

2. The method according to claim 1, wherein the observation service is executed as a component of the simulation environment.

3. The method according to claim 1, wherein the observation service either triggers at least one non-maskable interrupt of the computing unit of the simulation environment, which triggers the creation of the plurality of stack traces of the at least one computing unit of the simulation environment, or wherein the observation service triggers a non-maskable interrupt of the computing unit of the simulation environment multiple times, each of which triggers the creation of a stack trace of the at least one computing unit of the simulation environment so that a plurality of stack traces is also created.

4. The method according to claim 1, wherein the observation service unconditionally records the plurality of stack traces one after another, or records at fixed intervals of simulator real time.

5. The method according to claim 1, wherein the plurality of stack traces are created for all computing units of the simulation environment, and wherein, in the analysis step, the stack traces of all computing units are analyzed together and the most frequently executed control unit function is identified and is displayed.

6. The method according to claim 1, wherein, in the analysis step, the n most frequent control unit functions that the at least one computing unit has executed most frequently at the time of the creation of the respective stack trace are identified, and/or wherein the identified n most frequent control unit functions are displayed.

7. The method according to claim 1, wherein at least the most frequent control unit function that the respective computing unit has executed most frequently at the time of the creation of the respective stack trace is identified for multiple computing units in the analysis step, and wherein the identified most frequent control unit function for the respective computing unit is displayed and/or at least the most frequent control unit function is identified for all computing units.

8. A simulator comprising:
at least one computing unit; and
a simulation environment operated with a simulated computing unit in an operating state of the simulator on the computing unit,
wherein at least one control unit function of a control unit is executed with the simulated computing unit of the simulation environment with a zero-time assumption of a discretely advancing simulation time between successive simulation steps in an event-oriented discrete simulation on the simulator, and
wherein the simulator is designed and configured such that, in the operating state, the simulator performs the method according to claim 1.
